(19) United States
(12) Patent Application Publication
(10) Pub. No.: US 2005/0021904 A1
(43) Pub. Date: Jan. 27, 2005

(54) Mass memory device based on a flash memory with multiple buffers

(75) Inventors: Massimo Iaculo, S. Marco Evangelista (CE) (IT); Nicola Guida, Torre Del Greco (NA) (IT); Antonino Pollio, Vico Equense (NA) (IT); Angelo Dellamonica, Casaluce (CE) (IT); Pietro Baggi, Lallio (BG) (IT); Stefano Ghezzi, Treviolo (BG) (IT)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: STMICROELECTRONICS S.r.l., AGRATE BRIANZA (IT)

(21) Appl. No.: 10/861,341

(22) Filed: Jun. 4, 2004

(30) Foreign Application Priority Data
Jun. 5, 2003 (IT) MI2003A001126

(51) Int. Cl. G06F 12/08

(52) U.S. Cl. 711/103; 711/203; 711/170

(57) ABSTRACT

The mass memory device includes a flash memory (205) having a plurality of physical sectors, suitable to be erased individually, each one including a plurality of physical blocks and a method for emulating a random-access logical memory space having a plurality of logical sectors each one including a plurality of logical blocks, the logical sectors being grouped into at least one group. The method includes partitioning a random-access logical memory space into a plurality of logical sectors each one including a plurality of logical blocks, the logical sectors being grouped into at least one group of logical sectors; associating a corresponding data physical sector with each of the logical sectors and associating a plurality of corresponding buffer physical sectors with each group of logical sectors; setting at least one of the buffer physical sectors as an active buffer physical sector; writing each of the logical blocks into one of an available physical block of the corresponding data physical sector if the corresponding data physical sector is not full; and the corresponding active buffer physical sector if the corresponding data physical sector is full; setting another buffer physical sector as active, in response to the active buffer physical sector becoming full; and defragging each data physical sector which is full and associated with a logical sector having at least one logical block stored in the corresponding buffer physical sector which is full.

### CROSS-REFERENCE TO RELATED APPLICATIONS

This application is based upon and claims priority from prior Italian Application No. MI2003A001126, filed on Jun. 5, 2003 the entire disclosure of which is herein incorporated by reference.

### FIELD OF THE INVENTION

The present invention generally relates to a mass memory device and more particularly to a non-volatile mass memory device such as flash memory.

### BACKGROUND OF THE INVENTION

Mass memory devices (such as magnetic hard-disks) are commonly used in a processing system for storing data that must be preserved even when the power supply is off. A new technology for the mass memory devices (based on flash memories) has become particularly competitive in the last years. These mass memory devices are compact, robust and with low consumption; therefore, they result very advantageous especially in portable processing systems.

As it is known, a flash memory can be erased only in sectors having relatively large sizes (for instance, 128 Kbytes). Therefore, once a block of data has been written into the flash memory, this block of data cannot be updated any longer (unless the respective whole sector is erased).

A (physical or logical) interface module is then needed to emulate a random access to the mass memory device. For this purpose, the interface module provides a logical memory space, which is mapped onto the flash memory. Whenever a block of data must be updated, its new version is written into an available area of the flash memory, and the mapping information is modified accordingly.

When a sector is full, the space taken by the versions of the blocks of data written in this sector that are no longer valid is recovered through a defrag procedure. For example, the updated versions of the blocks of data are compacted into a new sector; at the end of the operation, the full sector is then erased.

Nevertheless, the defrag procedure is rather inefficient (especially when the flash memory has a NOR architecture, wherein the erasing is extremely slow). Particularly, this procedure makes the mass memory device completely unusable for a relatively long period (up to 2s). Therefore, the busy period can easily exceed a maximum allowable time-out; in this condition, the mass memory device is seen as being blocked by the processing system in which it is inserted.

Several architectures known in the art also envisage using portions of the flash memory as buffers for corresponding groups of sectors; in this way, when a block of data must be written into a full sector, such block of data is addressed to the associated buffer. This allows delaying the execution of the defrag procedure. Nevertheless, once the buffer is full as well, the same problems described above are experienced.

Accordingly, a need exist to overcome the above-mentioned drawbacks and shortcomings of the prior art, and to provide a device that is capable of being erased efficiently.

### SUMMARY OF THE INVENTION

Briefly, the present invention provides a mass memory device including a flash memory having a plurality of physical sectors, suitable to be erased individually, each one including a plurality of physical blocks and means for emulating a random-access logical memory space having a plurality of logical sectors each one including a plurality of logical blocks, the logical sectors being grouped into at least one group, wherein the means for emulating includes means for associating a data physical sector with each logical sector and a plurality of buffer physical sectors with each group of logical sectors, a buffer physical sector being set as active, means for writing each logical block into an available physical block of the corresponding data physical sector if not full or of the corresponding active buffer physical sector otherwise, means responsive to the active buffer physical sector becoming full for setting another buffer physical sector as active, and means for defragging each full data physical sector associated with a logical sector having at least one logical block stored in the full buffer physical sector.

Moreover, the present invention provides a corresponding emulation method; a program for performing the method and a product storing this program are also encompassed.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention will be apparent from the following detailed description taken in conjunction with the accompanying drawings in which:

FIG. 1 is a diagrammatical representation of a palmtop computer in which the mass memory device of the invention has been shown to be advantageously used,

FIG. 2 is a schematic block-diagram of the mass memory device,

FIG. 3a is a functional scheme of the mass memory device,

FIGS. 3b-3c show different examples of a physical-to-logical intra-sector table used in the mass memory device,

FIGS. 4a-4b represent the operation of the mass memory device in a simplified flow chart, and

FIG. 5 is a state diagram relating to a defrag procedure.

### DESCRIPTION OF THE PREFERRED EMBODIMENTS

It should be understood that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality.

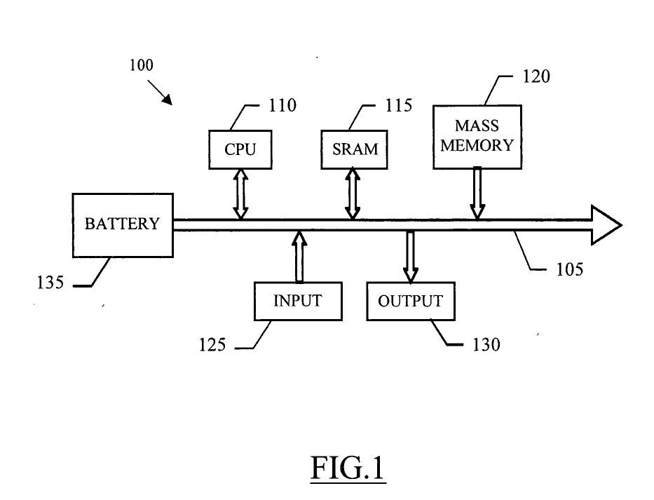

With reference in particular to FIG. 1, a palmtop computer 100 is illustrated in schematic form. The computer 100 is formed by several units, which are connected in parallel to a communication bus 105. In detail, a Central Processing Unit (CPU) 110 controls operation of the computer 100. The CPU 110 is connected to a working memory (SRAM) 115 in a conventional manner. Several peripheral units are further connected to the bus 105 (through respective drives). Particularly, the computer 100 is provided with a solid-state mass memory 120 (described in detail in the following). Moreover, the computer 100 includes an input unit 125 (for instance, a keypad) and an output unit 130 (for instance, a display). A battery 135 is used for supplying the computer 100.

Similar considerations apply if the computer has a different structure or includes other units; alternatively, the mass memory device of the present invention is used in a mobile telephone, in a digital still camera, or more generally in any other processing device.

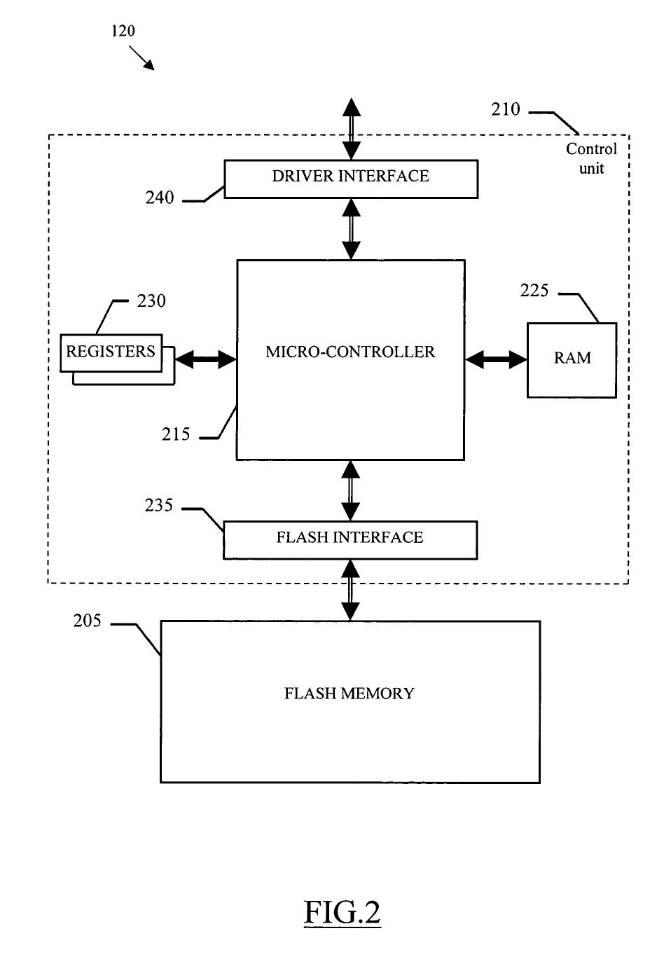

Passing now to FIG. 2, the mass memory device 120 consists of a memory card based on a flash memory 205 with NOR architecture. The flash memory 205 includes a matrix of memory cells, which is partitioned into sectors (for instance, 256 sectors each one of 128 Kbytes); all the memory cells of a sector must be erased at the same time (with each sector capable of being erased individually). Information is written into the flash memory 205 by pages, each one consisting of 16 bytes; once a page has been written into a corresponding location, this page cannot be modified any longer (unless the respective whole sector is erased).

A control unit 210 manages the flash memory 205 so as to emulate operation of a random access device. The control unit 210 is based on a micro-controller 215, which operation is managed by a firmware stored in the flash memory 205. A RAM 225 is used directly as a working memory by the micro-controller 215, which also accesses a series of high-speed registers 230. The micro-controller 215 communicates with an interface 235 for the flash memory 205 and with an interface 240 for the corresponding drive of the computer in which the memory card 120 is used.

Similar considerations apply if the flash memory is partitioned into a different number of sectors, if each sector and/or page has another size, or if the operation of the flash memory is controlled through equivalent means. In any case, the concepts of the present invention are also applicable when the flash memory has a different architecture (for instance, of the NAND type), or when the memory card is replaced with any other mass memory device based on a flash memory.

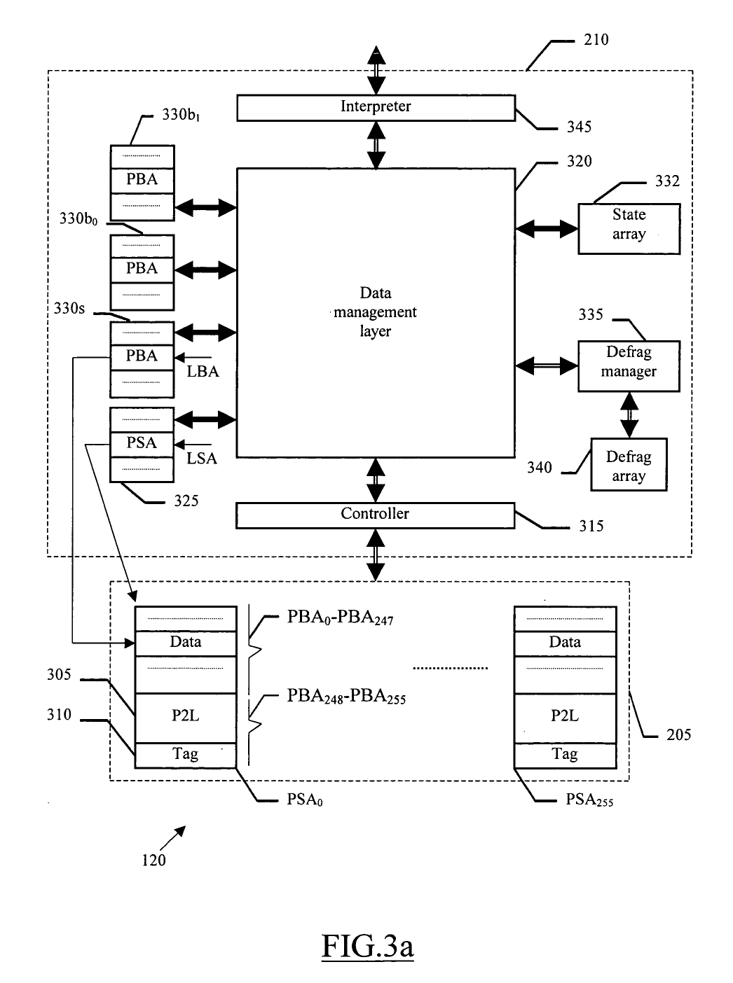

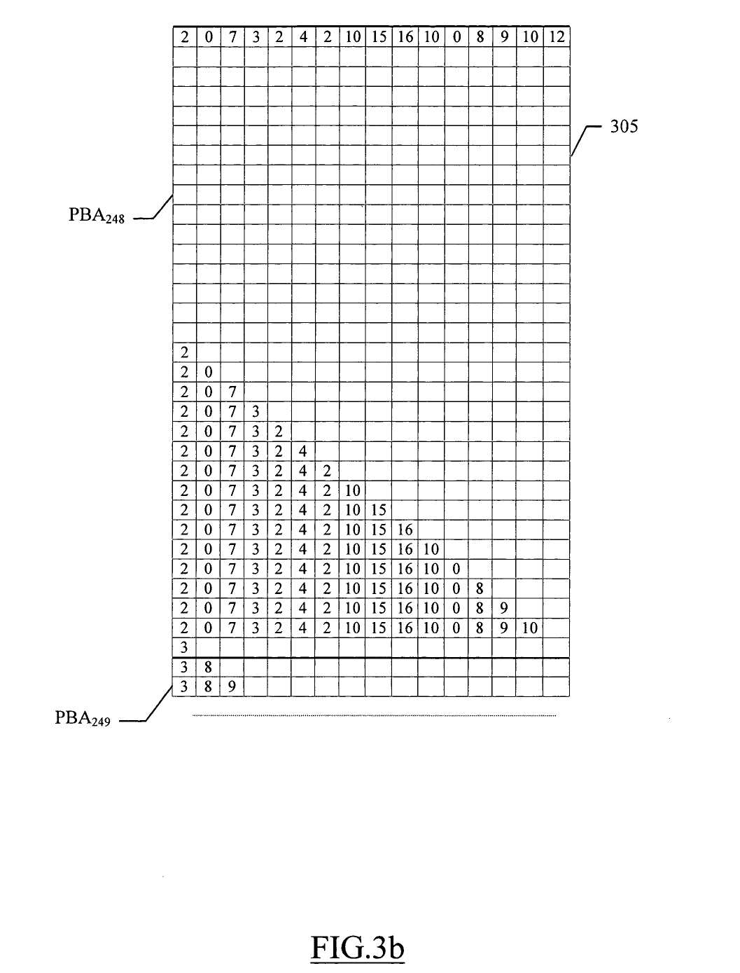

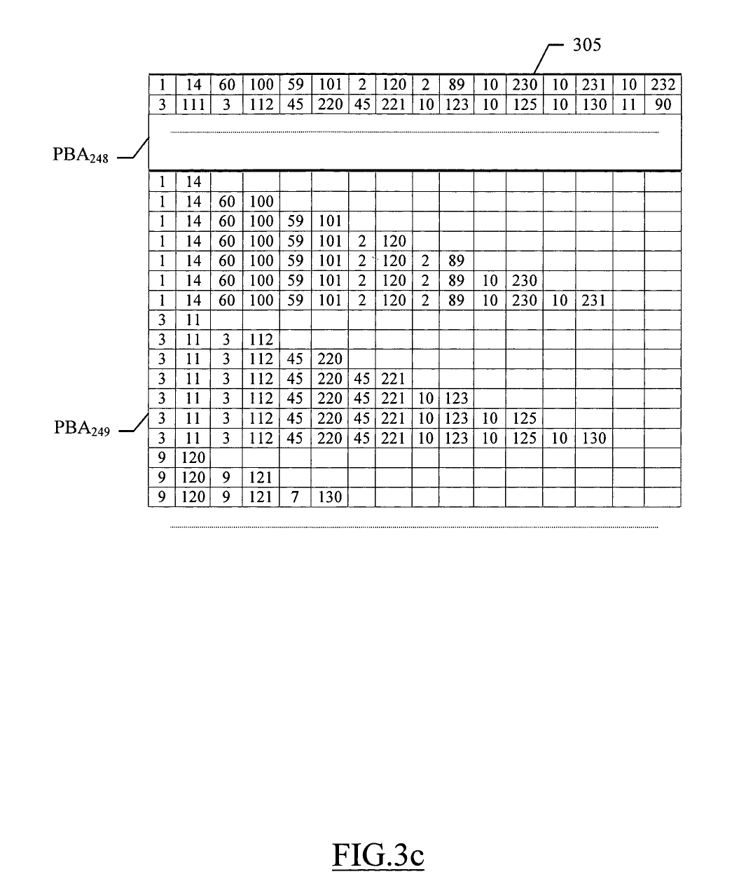

A functional scheme of the memory card 120 described above is illustrated in FIG. 3a. The memory card 120 manages a logical memory space that consists, for instance, of 252 logical sectors; a generic logical sector is identified by a logical sector address LSA₀-LSA₂₅₁ (1byte). Each logical sector consists of 248 logical blocks (each one of 512 bytes); a generic logical block is identified by a logical block address LBA₀-LBA₂₄₇ (1 byte).

The memory space that capable of being addressed from the outside consists of the first 244 logical sectors LSA₀-LSA₂₄₃. The logical sectors LSA₀-LSA₂₄₃ are organized into 4 groups, each one of 61 logical sectors (LG₀=LSA₀-LSA₆₀, LG₁=LSA₆₁-LSA₁₂₁, LG₂=LSA₁₂₂-LSA₁₈₂ and LG₃=LSA₁₈₃-LSA₂₄₃). Each group of logical sectors LG₀-LG₃ is statically associated with 2 of the further logical sectors LSA₂₄₄-LSA₂₅₁ (external to the addressable memory space), which sectors implement corresponding buffers. For instance, the group of logical sectors LG₀ is associated with the logical sector LSA₂₄₄ (first buffer) and with the logical sector LSA₂₄₅ (second buffer), the group of logical sectors LG₁ is associated with the buffers LSA₂₄₆ and LSA₂₄₇, and so on.

Each logical sector LSA₀-LSA₂₅₁ is dynamically associated with one of the (physical) sectors of the flash memory 205; a generic physical sector is identified by a physical sector address PSA₀-PSA₂₅₅ (1 byte). The number of the logical sectors LSA₀-LSA₂₅₁ (252) is lower than the number of the physical sectors PSA₀-PSA₂₅₅ (256). As a consequence, there will always be physical sectors in excess (256−252=4 in the example at issue) that are not associated with any logical sector. These physical sectors are used as transition areas during a defrag procedure (with a transition area that is always available for each group of logical sectors).

Each physical sector is partitioned into 256 physical blocks (each one of 512 bytes, that is 32 pages of 16 bytes); a generic physical block is identified by a physical block address PBA₀-PBA₂₅₅ (1 byte).

The first 248 physical blocks PBA₀-PBA₂₄₇ are used for storing data. Particularly, the different versions of the logical blocks of each logical sector are written in succession into the corresponding physical sector (from the physical block PBA₀ to the physical block PBA₂₄₇). As described in detail in the following, once the physical sector is full the logical blocks are written into one of the corresponding (physical) buffers that is currently active. When the active buffer is full as well, the logical blocks are written into the other buffer (that becomes active). Meanwhile, all the physical sectors associated with the logical sectors that have one or more logical blocks stored in the complete buffer are defragged. For each one of these logical sectors, all the logical blocks are compacted onto a transition area (taking into consideration their most updated version only, which is read in order from the active buffer, the non-active buffer and the physical sector); the transition area is then associated with the logical sector. The physical sector can now be erased, becoming available for another logical sector or as a transition area. At the end of the defragging of all the physical sectors, the full buffer is erased as well.

The remaining 8 physical blocks PBA₂₄₈-PBA₂₅₅ (8*32=256 pages) are used for storing service information. Particularly, a physical-to-logic (P2L) intra-sector table 305 is used for mapping the physical blocks PBA₀-PBA₂₄₇ onto the logical blocks LBA₀-LBA₂₄₇. The information stored in the P2L intra-sector table 305 differs according to whether the physical sector is associated with a logical sector belonging to the addressable memory space (LSA₀-LSA₂₄₃) or with a buffer (LSA₂₄₄-LSA₂₅₁).

In the first case, for each physical block PBA₀-PBA₂₄₇ the P2L intra-sector table 305 stores the address of the logical block that is written thereon. The P2L intra-sector table 305 is stored in a compressed (zipped) mode. In detail, when a logical block is written into the first physical block PBA₀, a page is inserted with the first byte equal to the corresponding logical block address; when a further logical block is written into the second physical block PBA₁, there is inserted a page consisting of the preceding page with the addition of the address of the further logical block (i.e., with the first byte and the second byte that store the addresses of the logical blocks written in the first physical block PBA₀ and in the second physical block PBA₁, respectively), and so on. When the sixteenth logical block is written, the corresponding page will be completely filled in with the addresses of the logical blocks that are written in the first 16 physical blocks PBA₀-PBA₁₅. The process likewise continues until the physical sector is full (i.e., all the physical blocks PBA₀-PBA₂₄₇ have been written). On the whole, the P2L intra-sector table 305 then consists of 248 pages. The pages that are completely filled in, or compressed, (INT[248/16]=15) are written in the first 15 locations of the physical block PB₂₄₈; the last page consisting of the remaining 8 logical block addresses (248−16*15=8) is written in the 16-th location of the physical block PB₂₄₈. The other pages that are not-completely filled in, or non-compressed, (248−16=232) are written in succession starting from the 17-th location of the physical block PB₂₄₈.

For instance, let us suppose that the logical blocks identified by the followings addresses are written in succession into the physical sector:

2 0 7 3 2 4 2 10 15 16 10 0 8 9 10 12 3 8 9

In this case, the content of the P2L intra-sector table 305 is represented in FIG. 3b.

Instead, if the physical sector is a buffer the physical blocks PBA₀-PBA₂₄₇ are used for writing logical blocks of the corresponding group of logical sectors. The P2L intra-sector table 305 must then store, for each physical block PBA₀-PBA₂₄₇, both the logical sector address and the logical block address (2 bytes) of the logical block that is written thereon. Therefore, the corresponding pages will be completely filled in every 8 writings of logical blocks. In this situation, the compressed pages (248/8=31) are written in the physical block PB₂₄₈; the remaining non-compressed pages (248−31=217) are written in succession starting from the physical block PB₂₄₉.

For instance, let us suppose that the logical blocks identified by the following pairs of logical sector/block addresses are written in succession into the buffer:

1/14 60/100 59/101 2/120 2/89 10/230 10/231 10/232 3/111 3/112 45/220 45/221 10/123 10/125 10/130 11/90 9/120 9/121 7/130

In this case, the content of the P2L intra-sector table 305 is represented in FIG. 3c.

Moreover, a bit of the two bytes used for storing the pair of logical sector/block addresses represents an invalidity flag INV₀-INV₂₄₇ for the corresponding logical block; as described in detail in the following, such flag is asserted when the logical block has been written into the buffer before the defragging of the corresponding physical sector.

Returning to FIG. 3a, the remaining last 8 locations of the physical block PB₂₅₅ are used as an overhead area to store a series of tags 310 relating to the physical sector. Particularly, two flags B0 and B1 are asserted when the physical sector is full, and one or more logical blocks of the corresponding logical sector are stored in the first buffer and in the second buffer, respectively. A flag END₁₃ DEF indicates the completion of the defrag procedure of the physical sector, while a flag ER₁₃ DONE indicates the completion of an erase operation of the physical sector (source of the defrag procedure). At the end, the tags 310 include the address of the logical sector associated with the physical sector. As it will be apparent in the following of the description, each one of the tags 310 mentioned above are capable of being updated only once between two consecutive erase operations of the physical sector; therefore, the 8 locations of the physical block PB₂₅₅ are more than enough to write in succession the different versions of those tags 310.

A controller 315 exports low-level firmware functions, which drive a (page-oriented) command interface of the flash memory 205. A data management layer 320 is implemented on top of the low-level firmware interface.

The data management layer 320 builds (into the RAM of the control unit) a logical-to-physical inter-sector table 325, which is used for mapping the logical sectors LSA₀-LSA₂₅₁ onto the physical sectors PSA₀-PSA₂₅₅; for this purpose, each logical sector address LSA₀-LSA₂₅₁ is used to access a location of the inter-sector table 325, which location stores the address PSA₀-PSA₂₅₅ of the corresponding physical sector.

Moreover, the data management layer 320 reads the P2L intra-sector table 305 of the physical sector corresponding to a current logical sector, and converts it into a corresponding logical-to-physical (L2P) intra-sector table 330s; particularly, each logical block address LBA₀-LBA₂₄₇ is used to access a location of the L2P intra-sector table 330s that stores the address PBA₀-PBA₂₄₇ of the corresponding physical block.

An L2P intra-sector table 330b₀ for the first buffer and an L2P intra-sector table 330b, for the second buffer associated with the group of the current logical sector are loaded in a similar way (reading and converting the corresponding P2L intra-sector tables 305). Each L2P intra-sector table 330b₀,330b₁ stores the addresses PBA₀-PBA₂₄₇ of the physical blocks corresponding to the (valid) logical blocks of the current logical sector only, and not of the other logical sectors of the respective group.

The data management layer 320 also exploits a state array 332. The state array 332 consists of a flag for each physical sector PBA₀-PBA₂₅₅ (256 in the example at issue); the flag is asserted when the corresponding physical sector is empty (i.e., it is completely erased).

The data management layer 320 controls a defrag manager 335 (implemented through a firmware state machine). The module 335 accesses a defrag array 340 for the current group of logical sectors. Particularly, the defrag array 340 consists of 61 flags, each one for a logical sector (LSA₀-LSA₆₀, LSA₆₁-LSA₁₂₁, LSA₁₂₂-LSA₁₈₂ or LSA₁₈₃-LSA₂₄₃); the flag is asserted when the corresponding logical sector has to be defragged.

The layer 320 exports a (logical sector- and block-oriented) data management interface. An interpreter 345 exploits this interface, in order to satisfy the requests received from the drive of the computer in which the memory card is used.

In any case, the concepts of the present invention are also applicable when the control unit is implemented with different functional layers, or when equivalent data structures are used (for instance, replacing the defrag array with a corresponding queue containing the addresses of the logical sectors to be defragged). Similar considerations apply if the memory card provides a different addressable memory space, or if each logical sector and/or block has another size. Alternatively, a different number of groups of logical sectors (down to a single one) are provided, or more buffers are associated with each group of logical sectors. Moreover, additional tags in one embodiment are used (for instance, to force the erasing of the physical sector or to store the number of erasures), and the like.

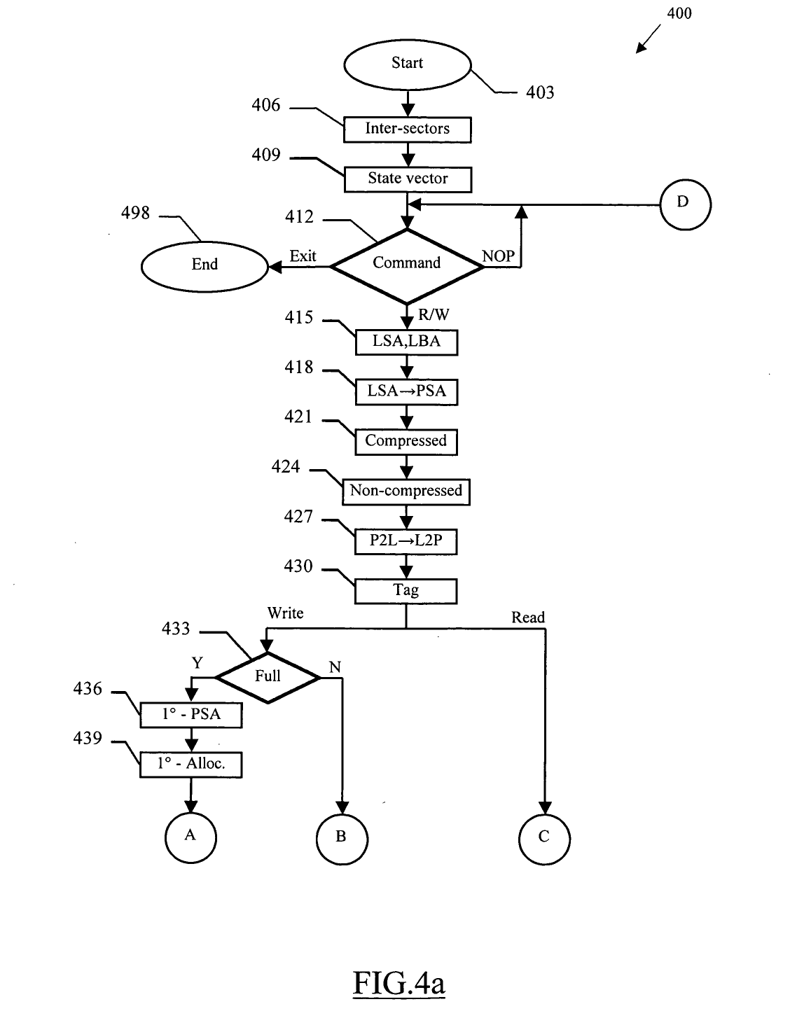

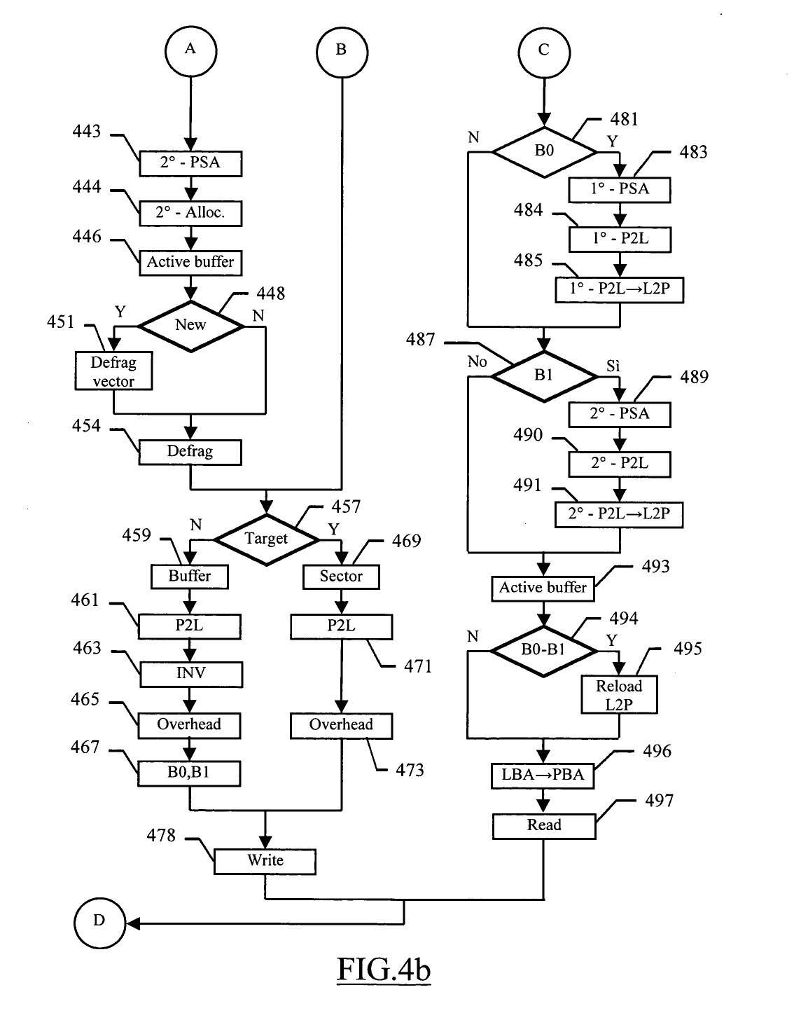

As shown in FIGS. 4a-4b, a method 400 is executed during operation of the memory card described above. The method begins at block 403 and then passes to block 406, wherein the inter-sector table is loaded. Proceeding to block 409, the state array is created (analyzing each one of the physical sectors PBA₀-PBA₂₅₅ of the flash memory). The method then enters an idle loop at block 412, waiting for an external command. When an external command is received, the blocks 415-497 are executed; the method then returns to the waiting block 412. Conversely, when the memory card is disabled (for instance, if the computer is turned off) the method ends at the final block 498.

Considering now block 415, the logical sector address and the logical block address of the relevant logical block are retrieved from the corresponding address received from the outside. The physical sector address associated with the logical sector is determined at block 418 (using the inter-sector table). Descending into block 421, the compressed pages of the respective P2L intra-sector table are read from the physical block PBA₂₄₈. The number of compressed pages uniquely determines the location in which the non-compressed page necessary for completing the P2L intra-sector table is stored; such non-compressed page is read at block 424. During this operation, a level of allocation of the physical sector, indicative of the number of physical blocks therein stored (from 0 when empty to 248 when full), is also calculated. Continuing to block 427, the P2L intra-sector table is converted into the corresponding L2P intra-sector table. The method then descends into block 430, wherein the tags of the physical sector are read from the respective overhead area.

The flow of activity then branches according to the type of command received from the outside. If the command is a writing command the blocks 433-478 are executed, whereas if the command is a reading command the blocks 481-497 are executed.

Considering now block 433 (writing command), a test is made to verify whether the physical sector is full. In the affirmative case (i.e., if the level of allocation previously calculated is equal to 248), the physical sector address PSA₀-PSA₂₅₅ of the first buffer associated with the group to which the logical sector belongs is determined at block 436; for this purpose, the dedicated location of the inter-sector table is accessed (for instance, the location 244 for the first group of logical sectors LG₀, the location 246 for the second group of logical sectors LG₁, and so on). The method continues to block 439, wherein the level of allocation of the first buffer is calculated (reading the corresponding P2L intra-sector table). Likewise, the physical sector address PSA₀-PSA₂₅₅ of the second buffer is determined at block 443, and the respective level of allocation is calculated at block 444.

The method then identifies the current active buffer at block 446. For this purpose, it should be noted that the active buffer must have one or more physical blocks available for writing; when the active buffer is being completed (after the writing of its last but one physical block), the other buffer (previously erased) becomes active. Therefore, the method verifies whether the first buffer stores less than 248 logical blocks and at the same time the second buffer stores a number of logical blocks different then 247. If both conditions are satisfied, the first buffer is set as active; otherwise, the second buffer is set as active.

Passing to block 448, a test is made to verify whether it is necessary to re-load the defrag array. This condition occurs when the logical sector does not belong to the same group of the-logical sector involved by the previous operation on the mass memory device or whenever the active buffer has been completed (so that the other buffer becomes active); in both cases, the defrag array is created at block 451, by asserting the flags corresponding to the logical sectors having at least one logical block stored in the non-active buffer (respective flags B0 or B1 asserted); the method then passes to block 454. Conversely, the method descends into block 454 directly. Considering now block 454, the defrag manager is invoked (as described in detail in the following). The method then passes to block 457. The same block 457 is reached from the test block 433 directly if the physical sector is not full.

Considering now block 457, the method verifies again whether the physical sector is full. If the physical sector is full, the blocks 459-467 are executed; conversely (i.e., if the physical sector had not been completed yet or it has just been defragged), the blocks 469-473 are executed. In both cases, the method joints at block 478.

With reference in particular to block 459 (full physical sector), the active buffer is set as the target of the writing operation. The method then proceeds to block 461, wherein the new page needed for updating the corresponding P2L intra-sector table is determined (according to the writing operation to be performed). Particularly, if the last page of the P2L intra-sector table was not full, the new page is obtained by adding the pair of logical sector/block addresses of the logical block to be written to the last page; otherwise, the new page simply consists of this pair of logical sector/block addresses.

The method then verifies at block 463 whether an exception condition occurred, in which the logical block must be written into the active buffer but the physical sector is still to be defragged (corresponding flag in the defrag array asserted); as described in detail in the following, this situation can occur when the defrag manager was not able to compact this physical sector because it was performing an erase operation on the flash memory. In the affirmative case, the invalidity flag associated with the first available physical block in the active buffer should be asserted.

The method then passes to block 465, wherein the information determined above is written into the overhead area of the active buffer. Moreover, if the writing operation will involve the storing of a logical block into the active buffer for the first time with respect to the logical sector, the corresponding flag B0 or B1 is asserted at block 467 into the overhead area of the physical sector.

Considering instead block 469 (non-full physical sector), this physical sector is set as target of the writing operation. The method then proceeds to block 471, wherein the new page needed for updating the corresponding intra-sector table is determined. As in the preceding case, if the last page of the P2L intra-sector table was not full, the new page is obtained by adding the address of the logical block to be written to the last page; otherwise, the new page simply consists of this logical address. The method then passes to block 473, wherein the information determined above is written into the overhead area of the physical sector.

With reference now to block 478, the logical block is actually written into the first available physical block of the target physical sector (physical sector or active buffer). The flow of activity then returns to block 412 (waiting for a new external command).

Considering instead block 481 (reading command), there is determined whether the logical sector has one or more logical blocks that are stored in the first buffer (flag B0 asserted). In the affirmative case, the method passes to block 483, wherein the physical sector address PSA₀-PSA₂₅₅ of the first buffer is determined (repeating the same operations described above with reference to block 436). Continuing to block 484, the L2P intra-sector table of the first buffer is loaded and the corresponding level of allocation is calculated at the same time (as at block 439).

The method continues to block 485, wherein the P2L intra-sector table of the first buffer is converted into the corresponding L2P intra-sector table. During this operation, there are taken into account the logical blocks stored in the first buffer for the current logical sector only (and not for the other logical sectors of the same group). The method then continues to block 487. The block 487 is instead reached from the test block 481 directly if the logical sector does not have any logical block stored in the first buffer.

With reference now to block 487, there is determined whether the logical sector has one or more logical blocks that are stored in the second buffer (flag B1 asserted). In the affirmative case, the same operations described above with reference to the blocks 483-485 are repeated for the second buffer at blocks 489-491; the method then continues to block 493. Conversely, the block 493 is reached from block 487 directly.

Passing then to block 493, if the logical sector has any logical blocks stored in at least one buffer, the method identifies the buffer that is currently active (repeating the same operations described above with reference to block 446). A test is performed at block 494 to verify whether the logical sector has any logical blocks stored in both the buffers (flags B0 and B1 asserted). In the affirmative case, the L2P intra-sector table of the active buffer is loaded again at block 495 taking into account the invalidity flags INV₀-INV₂₄₈ as well. Particularly, if the physical sector has already been defragged (i.e., the corresponding defrag flag is asserted), any logical blocks with the invalidity flags INV₀-INV₂₄₈ asserted are rejected; indeed (as described in detail in the following), these logical blocks have already been copied into the physical sector during the defrag procedure, so that they are no longer valid. The method then continues to block 496. Conversely, the block 496 is reached from block 494 directly.

Considering now block 496, the address of the physical block that stores the requested logical block is determined. Particularly, the physical block address is retrieved from the location associated with the logical block address in the L2P intra-sector table of the active buffer (if available); otherwise, the physical block address is retrieved (in order) from the L2P intra-sector table of the non-active buffer or from the L2P intra-sector table of the physical sector. This ensures accessing the most updated version of the logical block. With reference now to block 497, the physical block so determined is then actually read (from the active buffer, the non-active buffer or the physical sector), and the flow returns to block 412.

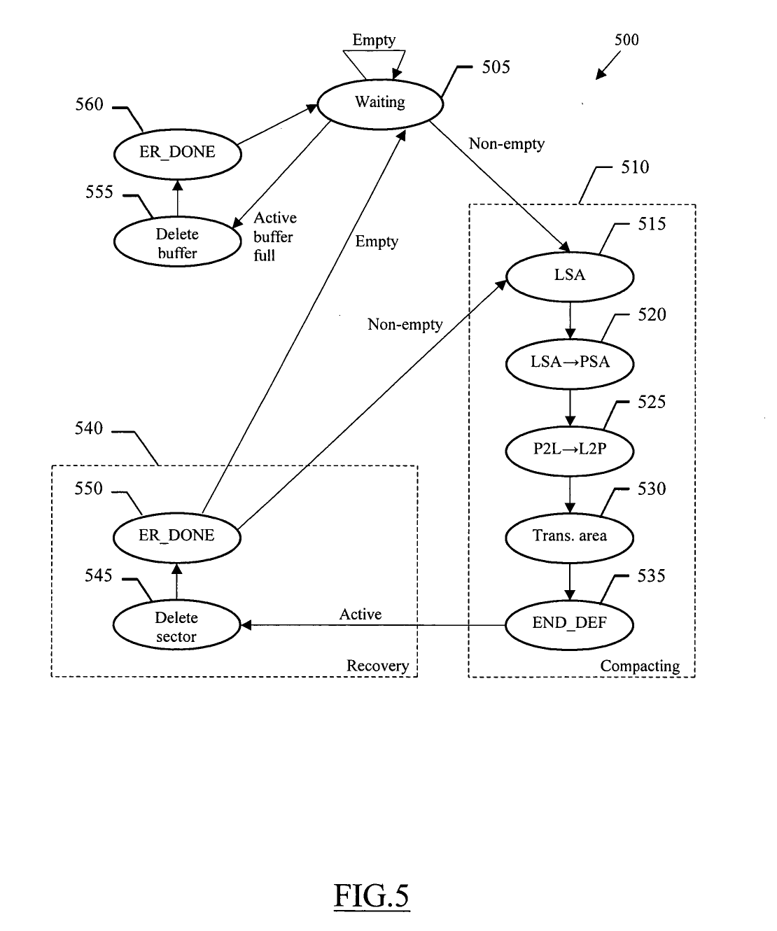

As shown in FIG. 5, the defrag manager implements a process that is represented by a state diagram 500. At the beginning, the process is in a waiting state 505. In response to an enabling command, if no logical sector has to be defragged (i.e., all the flags of the defrag array are deasserted), the process remains in the waiting state 505; conversely, the process enters a compacting state 510.

More in detail, the process passes to a state 515, wherein a logical sector to be defragged is selected. The selection is performed giving priority to the logical sector involved by the writing operation that is in progress (if the corresponding flag of the defrag array is asserted). Conversely, if the logical sector involved by the writing operation does not have to be defragged, the logical sector corresponding to the first flag asserted in the defrag array is selected.

Passing to the state 520, the address of the physical sector associated with the selected logical sector is determined. The process continues to the state 525, wherein the L2P intra-sector tables for the first and the second buffers are built (repeating the same operations described above with reference to blocks 483-485 and 489-491, respectively). Moreover, there is likewise built the L2P intra-sector table for the physical sector as well, if different than the one involved by the writing operation (while this table is already available otherwise, having been created during the writing operation). Proceeding to the state 530, the first empty physical sector (corresponding flag in the state vector asserted) among the available physical sectors (i.e., being not assigned in the inter-sector table) is set as transition area; at the same time, the corresponding flag in the state array is deasserted. The most updated version of all the logical blocks is read in order from the active buffer, the non-active buffer or the physical sector. Each one of these logical blocks is-written in succession into the available physical blocks of the transition area; the P2L intra-sector table of the transition area is then updated accordingly.

At the end, the process passes to a state 535, wherein the inter-sector table is updated so as to associate the logical sector with the transition area (wherein the respective logical blocks have been copied); in this condition, the flags B0 and B1 are deasserted, so that all the logical blocks stored in the buffers are automatically invalidated. Moreover, the flag in the defrag array corresponding to the logical sector is deasserted and the flag END₁₃ DEF of the physical sector previously associated with the logical sector is asserted to indicate the completion of the compacting operation.

In response to a next enabling command, the process enters a state 540 for recovering the space in the flash memory. In detail, the process passes to a state 545 wherein the physical sector previously processed is completely erased. Continuing to the state 550, the corresponding flag in the state array is asserted; at the same time, the flag ER₁₃ DONE is asserted to indicate the completion of the recovery operation.

If all the physical sectors have been defragged (i.e., all the flags in the defrag array are deasserted), the process passes to the waiting state 505; conversely, the process returns to the compacting state 510 (to repeat the operation described above on a, further physical sector to be defragged).

With reference again to the waiting state 505, in response to the completion of the active buffer the process passes to the state 555, wherein the non-active buffer is erased. Continuing to the state 560, the corresponding flag in the state array and the flag ER₁₃ DONE are asserted. The process then returns to the waiting state 505.

It should be emphasized that the operations for compacting and recovering the space in the flash memory (with the erasing of the compacted physical sectors, and at the end of the full buffer as well) are performed during two distinct writing operations. In this way, the overall length of each writing operation is substantially reduced. Particularly, in the worse case the length of the writing operation is substantially equal to the erase time of a physical sector (typically, 1 s). Moreover, in the example at issue the number of logical sectors in each group (61) is lower than half the number of logical blocks that are capable of being written into the buffer (248/2=124). Therefore, when the active buffer is full (after 248 writing operations) the defrag procedure will be certainly completed (since it requires, in the worse case in which all the logical sectors of the group have to be defragged, at most 61*2=122 writing operations); in this way, before the active buffer is full, the defrag procedure will be always already finished (with the erasing of the other buffer).

The flags END₁₃ DEF and ER₁₃ DONE allow guaranteeing the coherence of the stored data, even when a sudden interruption of the operation on the mass memory device occurs (for instance, caused by its removal from the computer during the defrag procedure). Particularly, the assertion of both the flags END₁₃ DEF and ER₁₃ DONE indicates the correct completion of the defrag procedure. If the flag ER₁₃ DONE is deasserted (but the flag END₁₃ DEF is asserted), the procedure has been interrupted after the compacting operation; therefore, it could be necessary to repeat the recovery operation (for instance, if the procedure has been interrupted during the erase operation). In this way, it is possible to restore a coherent condition of the mass memory device in most practical situations.

In any case, the concepts of the present invention are also applicable when the operation of the mass memory device implements an equivalent method, or when the defrag manager realizes a process represented by a similar state diagram. Similar considerations apply if additional functions are envisaged (for instance, with algorithms to uniform the use of the different physical sectors of the flash memory), and the like.

More generally, the present invention provides a mass memory device including a flash memory. The flash memory has a plurality of physical sectors (suitable to be erased individually); each physical sector includes a plurality of physical blocks. The mass memory device is further provided with means for emulating a random-access logical memory space. The logical memory space has a plurality of logical sectors; each logical sector includes a plurality of logical blocks. The logical sectors are grouped into one or more groups. In the mass memory device of the invention, the means for emulating includes means for associating a data physical sector with each logical sector and a plurality of buffer physical sectors with each group of logical sectors; a buffer physical sector is set as active. Means is provided for writing each logical block into an available physical block of the corresponding data physical sector (if not full) or of the corresponding active buffer physical sector (otherwise). The mass memory device also includes means that responds to the active buffer physical sector becoming full; this means sets another buffer physical sector as active. Moreover, further means is used for defragging each full data physical sector associated with a logical sector having at least one logical block stored in the full buffer physical sector.

The solution according to the present invention substantially improves the efficiency of the defrag procedure. This involves a general increase of the performance of the whole mass memory device.

Particularly, the proposed architecture allows exploiting the whole information in a full buffer during the defrag procedure.

In this way, the length of the defrag procedure is capable of being distributed throughout more operations of the mass memory device; accordingly, there is avoided (or in any case strongly reduced) the risk that the busy period of the mass memory device (caused by the operations relating to the defrag procedure) exceeds the maximum allowable waiting time (and then the mass memory device is seen as blocked by the processing system in which it is inserted).

This advantage is perceived especially in a mass memory device based on a flash memory of the NOR type (wherein the erasing of a sector is extremely slow); in any case, the use of the proposed method in mass memory devices based on different flash memories (for instance, of the NAND type) is contemplated and within the scope of the present invention.

The preferred embodiment of the invention described above offers further advantages.

Particularly, the defrag procedure is partitioned into a compacting operation and a next recovery operation.

The proposed characteristic allows optimizing the management of such procedure.

Preferably, the compacting and recovery operations are actuated alternatively during every writing operation in the active buffer (relating to logical sectors of the same group).

In this way, it is possible to delay the defrag procedure as far as possible (without any negative effect on the operation of the mass memory device).

In an advantageous embodiment of the invention, the defrag procedure is implemented through a physical transition sector (being dynamically identified).

The proposed structure is simple to implement and flexible.

In any case, the present invention leads itself to be implemented even with a different defrag procedure, actuating the compacting and recovery operations at every writing, performing the defragging in background, or also using different transition areas.

As a further improvement, the selection of the physical sector to be defragged is performed giving priority to the physical sector involved by the writing operation.

This avoids writing logical blocks into the active buffer that will be no longer valid at the next defragging of the physical sector.

Preferably, when it is not possible to perform the defrag procedure immediately, a mechanism is provided for invalidating, after the defragging, the logical blocks written in the meantime into the active buffer.

In any case, the present invention leads itself to be implemented even taking into account the non-active buffer only during the defrag procedure, or selecting the physical sectors to be defragged in a different way (for instance, always forcing the defragging of the physical sector involved by the writing operation, thereby avoiding the need of providing a mechanism to invalidate the logical blocks).

As a further advantage, flags are provided to indicate the completion of both the compacting operation and the recovery operation.

This allows restoring a coherent condition of the mass memory device following a sudden interruption of its operation.

Preferably, only the inter-sector table and a structure at most consisting of three intra-sector tables (for the current logical sector and possibly the associated buffers) are loaded into the working memory.

This solution substantially reduces the working memory space exploited for the operation of the mass memory device.

As a further improvement, each physical sector stores an address of the corresponding logical sector; this information is used for creating the inter-sector table.

The proposed structure is easy to implement, but at the same time effective.

A way to further improve the solution of the invention is to write the intra-sector table in physical-to-logical mode in each physical sector (being converted into the logical-to-physical mode at the loading into the working memory).

In this way, it is possible to avoid writing the whole intra-sector table in the physical sector at every writing operation.

Advantageously, the logical blocks written into the active buffer before the defragging of the physical sector (corresponding invalidity flag asserted) are discarded during this operation.

Accordingly, those logical blocks are automatically invalidated in a very straight forward manner.

In any case, the solution of the invention leads itself to be implemented even without any flags, or managing the tables in a different way; alternatively, other data structures are stored in the physical sectors, or different mechanisms are provided for invalidating the logical blocks.

Advantageously, the physical-to-logical intra-sector table is stored in a compact mode.

This allows optimizing the management of consecutive writing and reading operations.

As a further improvement, the full pages are written into adjacent locations.

In this way, it is minimized the number of pages to be read for reconstructing the logical-to-physical intra-sector table.

Alternatively, the pages are always written in succession (if they are both non-full and full), or the physical-to-logical intra-sector table is stored in a different mode.

Without detracting from its general applicability, the solution of the present invention is particularly advantageous in a mass memory device that includes an internal control unit (which directly manages the flash memory).

In any case, the implementation of the proposed emulation method outside the mass memory device (for instance, in the drive of the computer) is contemplated and within the scope of the invention.

Advantageously, the solution according to the present invention is implemented through a program stored on a suitable medium.

Alternatively, the program is stored on the computer or a computer program product or computer readable-medium (e.g. diskettes, flash memory, downloadable) in which the mass memory device is used, or more generally is provided in any other form directly loadable into the working memory of generic logical means. However, the method of the present invention leads itself to be implemented even partially or completely in hardware.

Although a specific embodiment of the invention has been disclosed, it will be understood by those having skill in the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

1. A mass memory device comprising:
an interface to a flash memory, wherein the flash memory has a plurality of physical sectors each capable of being individually erased, and wherein each of the physical sectors include a plurality of physical blocks; and
means for emulating a random-access logical memory space having a plurality of logical sectors each of the logical sectors including a plurality of logical blocks, the logical sectors being grouped into at least one group of logical sectors, wherein the means for emulating includes
means for associating a corresponding data physical sector with each of the logical sectors and for associating a plurality of corresponding buffer physical sectors with each group of logical sectors;
at least one of the corresponding buffer physical sectors being set as an active buffer physical sector;
means for writing each of the logical blocks into one of
an available physical block of the corresponding data physical sector when the corresponding physical sector is not full, and
the active buffer physical sector when the corresponding physical sector is full;
means responsive to the active buffer physical sector becoming full for setting another buffer physical sector as active from the buffer physical sectors; and
means for defragging each corresponding data physical sector which is full and is associated with a logical sector having at least one logical block stored in one of the corresponding buffer physical sectors which is full.

2. The memory device according to claim 1, wherein the means for defragging each corresponding data physical sector includes means for compacting an updated version of each of the logical blocks are written in one of:
the corresponding data physical sector which is full, and
the corresponding buffer physical sectors;
means for erasing the data physical sector which is full in response to the completion of the compacting thereof; and
means for erasing one of the corresponding buffer physical sectors in response to the completion of the compacting of each of the corresponding data physical sector which is full and is associated therewith.

3. The memory device according to claim 2, further including:
means for alternately enabling the means for compacting, the means for erasing the data physical sector and the means for erasing the buffer physical sector during each writing operation of a logical block into the active buffer physical sector.

4. The memory device according to claim 2, wherein the means for emulating further includes means for associating a corresponding transition physical sector with each group of logical sectors, the means for compacting including means for copying the updated version of each of the logical blocks into the corresponding transition physical sector and means for associating the logical sector corresponding to the corresponding data physical sector which is full with the corresponding transition physical sector in response to the completion of the copying.

5. The memory device according to claim 2, wherein the means for compacting further includes means for storing an indication of the completion of the compacting, and wherein the means for erasing the data physical sector and the means for erasing the buffer physical sector further includes means for storing an indication of the completion of the erasing.

6. The memory device according to claim 2, wherein the means for defragging further includes means for selecting, for the defragging, one of
the data physical sector which is full and involved by the writing operation and is available to be defragged and
another of the data physical sector which is full and available to be defragged.

7. The memory device according to claim 6, further including
means for invalidating each of the logical blocks written into the active buffer physical sector before defragging the corresponding data physical sector which is full in response to the defragging thereof.

8. The memory device according to claim 1, wherein the means for emulating further includes a volatile memory and means for loading, into the volatile memory, an inter-sector mapping structure associating each of the logical sectors with the corresponding data physical sector and a logical-to-physical intra-sector mapping structure of a current logical sector associating each of the logical blocks of the current logical sector with a corresponding physical block in which each of the logical blocks is written.

9. The memory device according to claim 8, wherein the means for emulating further includes means for storing, in each of the physical sectors, an address of the corresponding logical sector, the means for loading the inter-sector mapping structure including means for reading the addresses of the logical sectors of each physical sector and for creating the inter-sector mapping structure according to the read addresses of the logical sectors.

10. The memory device according to claim 8, wherein the means for emulating further includes means for storing, in each of the physical sectors, a physical-to-logical intra-sector mapping structure associating each of the physical blocks of the physical sectors with a corresponding logical block written in each of the physical blocks, the means for loading the logical-to-physical intra-sector mapping structure of the current logical sector including means for reading the physical-to-logical intra-sector mapping structure of the corresponding physical sector and the physical-to-logical intra-sector mapping structure of each corresponding buffer physical sector storing at least one logical block of the current logical sector, and for creating the logical-to-physical intra-sector mapping structure according to each read physical-to-logical intra-sector mapping structure.

11. The memory device according to claim 10, wherein the means for invalidating includes means for associating an invalidity flag with each logical block written into the active buffer physical sector before defragging the corresponding data physical sector, and wherein the means for creating the logical-to-physical intra-sector mapping structure includes means for discarding the logical blocks associated with the invalidity flag if the data physical sector has already been defragged.

12. The memory device according to claim 10, wherein each physical block includes a plurality of locations each one for a page suitable to be written individually, the means for storing in each physical sector the physical-to-logical intra-sector mapping structure including means for writing a sequence of pages in response to the writing of the logical blocks in the physical sector, each page including an address of the corresponding logical block with the addition of a preceding page if non-full.

13. The memory device according to claim 12, wherein the means for writing the sequence of pages includes means for writing one or more full pages in adjacent locations of the physical sector.

14. A method of emulating a random-access logical memory space in a mass memory device including a flash memory having a plurality of physical sectors, suitable to be erased individually, each of the physical sectors including a plurality of physical blocks, the method comprising:
partitioning a random-access logical memory space into a plurality of logical sectors each one including a plurality of logical blocks, the logical sectors being grouped into at least one group of logical sectors;
associating a corresponding data physical sector with each of the logical sectors and associating a plurality of corresponding buffer physical sectors with each group of logical sectors;
setting at least one of the buffer physical sectors as an active buffer physical sector;
writing each of the logical blocks into one of
an available physical block of the corresponding data physical sector if the corresponding data physical sector is not full; and
the corresponding active buffer physical sector if the corresponding data physical sector is full;
setting another buffer physical sector as active, in response to the active buffer physical sector becoming full; and
defragging each data physical sector which is full and associated with a logical sector having at least one logical block stored in the corresponding buffer physical sector which is full.

15. The method according to claim 14, wherein the defragging each full data physical sector includes:
compacting an updated version of each logical block written in the full data physical sector or in the corresponding buffer physical sectors;
erasing the data physical sector which is full in response to the completion of the compacting thereof; and
erasing the buffer physical sector which is full in response to the completion of the compacting of each of the data physical sector which is full and associated therewith.

16. The method according to claim 15, further including:
alternately enabling the compacting, the erasing of the corresponding data physical sector or the erasing of the corresponding buffer physical sector during each writing operation of a logical block into the active buffer physical sector.

17. The method according to claim 15, further including:
associating a transition physical sector with each group of logical sectors, the compacting including:
copying the updated version of each logical block into the corresponding transition physical sector, and
associating the logical sector corresponding to the full data physical sector with the transition physical sector in response to the completion of the copying.

18. The method according to claim 15, wherein the compacting further includes:
storing an indication of the completion of the compacting, and wherein the erasing the data physical sector and the erasing the corresponding buffer physical sector further includes storing an indication of the completion of the erasing.

19. The method according to claim 15, wherein the defragging further includes:
selecting for the defragging one of:
the corresponding data physical sector which is full and involved by the writing operation if available to be defragged; and
another of the data physical sectors which is full to be defragged otherwise.

20. The method according to claim 19, further including the invalidating each logical block written into the active buffer physical sector before defragging the corresponding full data physical sector in response to the defragging thereof.

21. The method according to claim 14, further including:
loading into a volatile memory an inter-sector mapping structure associating each logical sector with the corresponding physical sector and a logical-to-physical intra-sector mapping structure of a current logical sector associating each logical block of the current logical sector with a corresponding physical block in which the logical block is written.

22. The method according to claim 21, further including:
storing in each physical sector an address of the corresponding logical sector, the loading the inter-sector mapping structure including:
reading the addresses of the logical sectors of each physical sector and creating the inter-sector mapping structure according to the read addresses of the logical sectors.

23. The method according to claim 21, further including:
storing in each physical sector a physical-to-logical intra-sector mapping structure associating each physical block of the physical sector with a corresponding logical block written in the physical block, the loading the logical-to-physical intra-sector mapping structure of the current logical sector including:
reading the physical-to-logical intra-sector mapping structure of the corresponding physical sector and the physical-to-logical intra-sector mapping structure of each corresponding buffer physical sector storing at least one logical block of the current logical sector, and
creating the logical-to-physical intra-sector mapping structure according to each read physical-to-logical intra-sector mapping structure.

24. The method according to claim 23, wherein the invalidating includes:
associating an invalidity flag with each logical block written into the active buffer physical sector before defragging the corresponding data physical sector, and wherein the creating the logical-to-physical intra-sector mapping structure includes discarding the logical blocks associated with the invalidity flag if the data physical sector has already been defragged.

25. The method according to claim 23, wherein each physical block includes a plurality of locations each one for a page suitable to be written individually, the storing in each physical sector the physical-to-logical intra-sector mapping structure including:
writing a sequence of pages in response to the writing of the logical blocks in the physical sector, each page including an address of the corresponding logical block with an addition of a preceding page if non-full.

26. The method according to claim 25, wherein the writing the sequence of pages includes:
writing the full pages in adjacent locations of the physical sector.

27. A computer program product for emulating a random-access logical memory space in a mass memory device including a flash memory having a plurality of physical sectors, suitable to be erased individually, each of the physical sectors including a plurality of physical blocks, the computer program product comprising:
a storage medium readable by a processing circuit and storing computer instructions for execution by the processing circuit for performing a method comprising:
partitioning a random-access logical memory space into a plurality of logical sectors each one including a plurality of logical blocks, the logical sectors being grouped into at least one group of logical sectors;
associating a corresponding data physical sector with each of the logical sectors and associating a plurality of corresponding buffer physical sectors with each group of logical sectors;
setting at least one of the buffer physical sectors as an active buffer physical sector;
writing each of the logical blocks into one of
an available physical block of the corresponding data physical sector if the corresponding data physical sector is not full; and
the corresponding active buffer physical sector if the corresponding data physical sector is full;
setting another buffer physical sector as active, in response to the active buffer physical sector becoming full; and
defragging each data physical sector which is full and associated with a logical sector having at least one logical block stored in the corresponding buffer physical sector which is full.
